(19) United States
(12) Patent Application Publication
(10) Pub. No.: US 2010/0038445 A1
(43) Pub. Date: Feb. 18, 2010

(54) COMPOSITE AND RELATED METHOD OF MAKING

(75) Inventor: Neil Sater, Solvang, CA (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(73) Assignee: MAGNUS CAPITAL, Orlando, FL (US)

(21) Appl. No.: 12/190,012

(22) Filed: Aug. 12, 2008

(51) Int. Cl. B05B 17/08; B44F 9/04; B29C 43/58

(52) U.S. Cl. 239/17; 428/15; 264/40.1

(57) ABSTRACT

A composite includes a substrate having a mounting surface and a first substrate side having an irregular profile, and a laminate attached to the mounting surface, a first laminate edge being substantially aligned with the first substrate side and substantially matching the profile thereof. The composite can advantageously be employed in a fountain assembly. A method of making a composite includes substantially aligning an edge of a stone laminate with a side of substrate, and attaching the stone laminate to a mounting surface of the substrate. The edge of the stone laminate substantially matches an irregular profile of the side of the substrate.

### FIELD OF THE INVENTION

The present invention relates to composites and a related method of making, and, more particularly, to fountain assemblies employing composites.

### BACKGROUND OF THE INVENTION

Many natural substances are prized for aesthetic reasons and used in a variety of architectural, art and design applications. However, completely natural substances can be difficult to work with for many reasons. For example, some natural materials may have an extremely high cost or may be very heavy for a particular application.

For instance, stone, such as slate, is popularly employed in fountain designs. Due to the weight of a stone slab, shipping a fountain employing a stone slab can be extremely costly. Additionally, mounting the fountain often requires costly and time-consuming reinforcement of the wall or other mounting surface.

In fountain applications, these concerns are addressed to some degree by the use of stone veneers. However, when viewed from the sides, it is clear that real stone is not being employed. The sides of the veneer may be hidden, for example by banding covering the edges of the veneer. This solution, however, does not replicate the appearance of a natural, rough-hewn stone slab.

### SUMMARY OF THE INVENTION

In view of the foregoing, it is an object of the present invention to provide an improved composite. According to an embodiment of the present invention, a composite includes a substrate having a mounting surface and a first substrate side having an irregular profile, and a laminate attached to the mounting surface, a first laminate edge being substantially aligned with the first substrate side and substantially matching the profile thereof.

According to another embodiment of the present invention, a fountain assembly includes a substrate having a mounting surface and a substrate side, the substrate side having an irregular profile, a stone laminate attached to the mounting surface, a laminate edge being substantially aligned with the substrate side and substantially matching the profile thereof, a fluid reservoir arranged to collect fluid passing over the stone laminate, a pump for pumping fluid from the reservoir to a position from which the fluid can pass over the stone laminate, and a fluid conduit for carrying the fluid, the fluid conduit extending at least partially between the fluid reservoir and the position.

According to a further embodiment of the present invention, a method of making a composite includes substantially aligning an edge of a stone laminate with a side of substrate, and attaching the stone laminate to a mounting surface of the substrate. The edge of the stone laminate substantially matches an irregular profile of the side of the substrate.

These and other objects, aspects and advantages of the present invention will be better understood in view of the drawings and the following detailed description of preferred embodiments.

### BRIEF DESCRIPTION OF THE DRAWINGS

FIG. 1 is a perspective view of a composite, according to an embodiment of the present invention;

FIG. 2 is an exploded view of the composite of FIG. 1;

FIG. 3 is a detailed view of area 3 of FIG. 1;

FIG. 4 is a perspective view of a fountain assembly including a composite, with hidden and removed elements shown in broken lines, according to another embodiment of the present invention; and

FIG. 5 is a flow diagram of a method of making a composite, according to a further embodiment of the present invention.

### DETAILED DESCRIPTION OF PREFERRED EMBODIMENTS

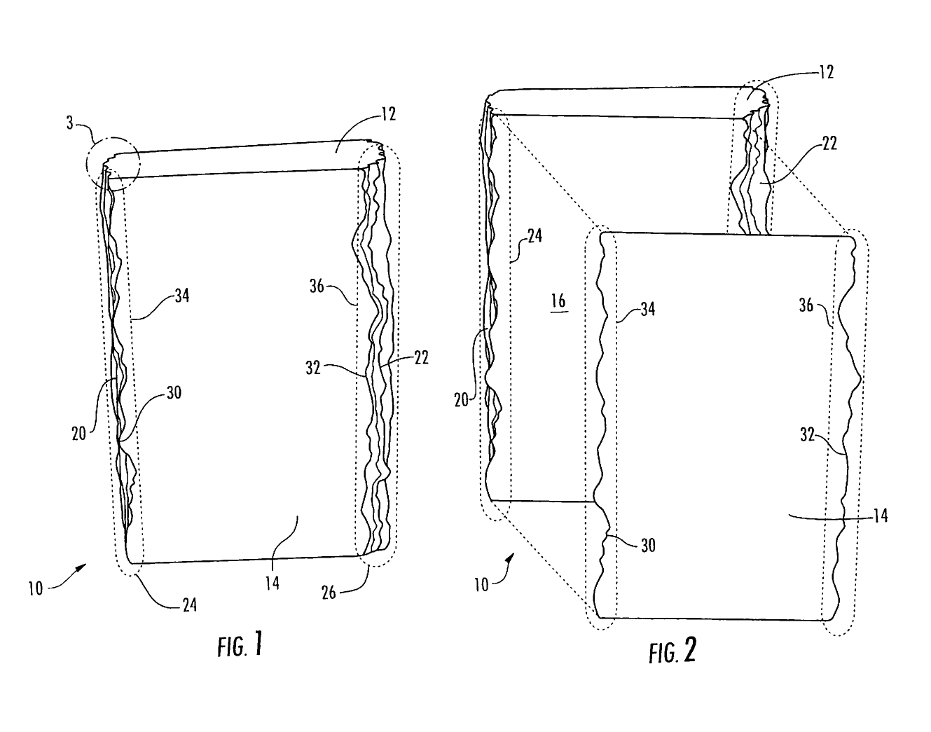

Referring to FIGS. 1 and 2, according to an embodiment of the present invention, a composite 10 includes a substrate 12 and a laminate 14. The laminate 14 is attached to a mounting surface 16 of the substrate 12. The substrate 12 includes first and second sides 20, 22. The sides 20, 22 have respective irregular profiles 24, 26. The laminate 14 has first and second edges 30, 32 with respective irregular profiles 34, 36. The irregular profiles 34, 36 of the edges 30, 32 substantially match the irregular profiles 24, 26 of the sides 20, 22.

The present invention is not necessarily limited to particular materials for the substrate 12 and laminate 14. However, according to one advantageous aspect of the invention, the substrate 12 is a relatively lightweight synthetic material, such as a resin or plastic and the laminate is stone, such as a thin ply of slate. The matched irregular edge profiles 24, 26 and 24, 36 create the appearance of a solid, rough-hewn stone slab but at a fraction of the weight.

Referring to FIGS. 1 and 3, sides 20, 22 (only side 20 is shown in the detailed view of FIG. 3) of the substrate 12 include a plurality of layers 40. The corresponding edges 30, 32 (only edge 30 is shown in the detailed view of FIG. 3) of the laminate 14 match the profile of the layer 40 most proximate to the mounting surface 16. Advantageously, this allows the composite 10 to closely replicate the appearance of foliated stone, like slate.

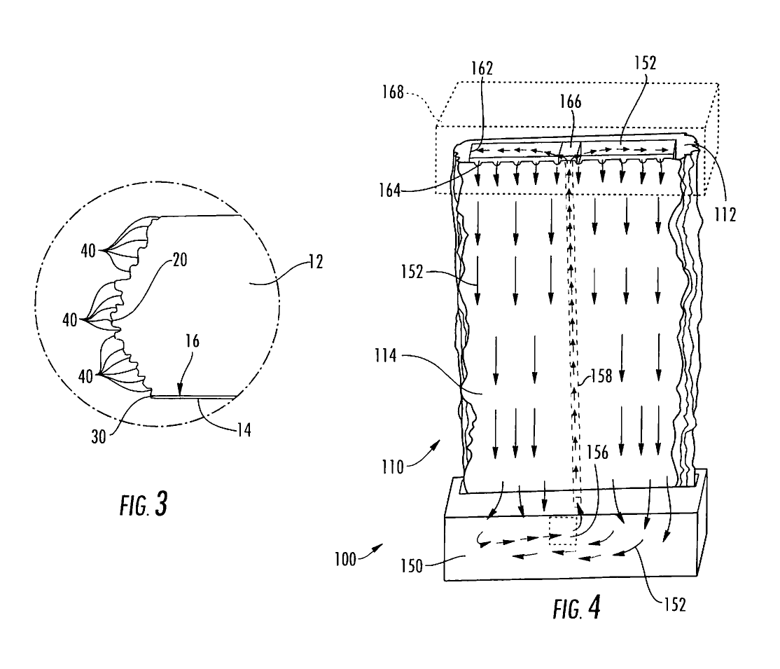

The composite of the present invention can be advantageously employed in many applications. For example, referring to FIG. 4, according to another embodiment of the present invention, a fountain assembly 100 includes a composite 110. The composite 110 includes a substrate 112 and a laminate 114. A fluid reservoir 150 is arranged along the bottom of the composite 110 to collect fluid (fluid flow represented generally by arrows 152) passing over the laminate 114.

A pump 156 is arranged within the fluid reservoir 150 for pumping the collected fluid to the top of the laminate 114, where the fluid can again pass over the laminate. The fluid is pumped through a fluid conduit 158, such as a tube or pipe.

A collection volume 162 is defined between corresponding portions of the substrate 112 and laminate 114. To facilitate even flow of water over the laminate 114, an upper edge 164 of the laminate 114 is crenellated in the area of the collection volume 162. A blocking plate 166 is arranged over the upper end of the fluid conduit 158 to help channel fluid leaving the conduit 158 into the collection volume 162. A decorative top cap 168 can be added to conceal the top of the composite 110. Mounting brackets, lights, and other structures can also be added.

It will appreciated that use of the composite 110 with a stone laminate 114 can replicate the appearance of a rough-hewn slab at a fraction of the weight, greatly facilitating the transportation and hanging of the fountain assembly 100. Use of a molded substrate 112 also advantageously facilitates assembly of the fountain assembly 100. For instance, the fluid conduit 158 can be arranged within the substrate 112. The fluid conduit 158 and other structures, such as reinforcing strips, can be molded within the substrate. The collection volume 162 can be readily defined between corresponding portions of the substrate 112 and laminate 114, for example, by forming a recess into the substrate 112 during molding.

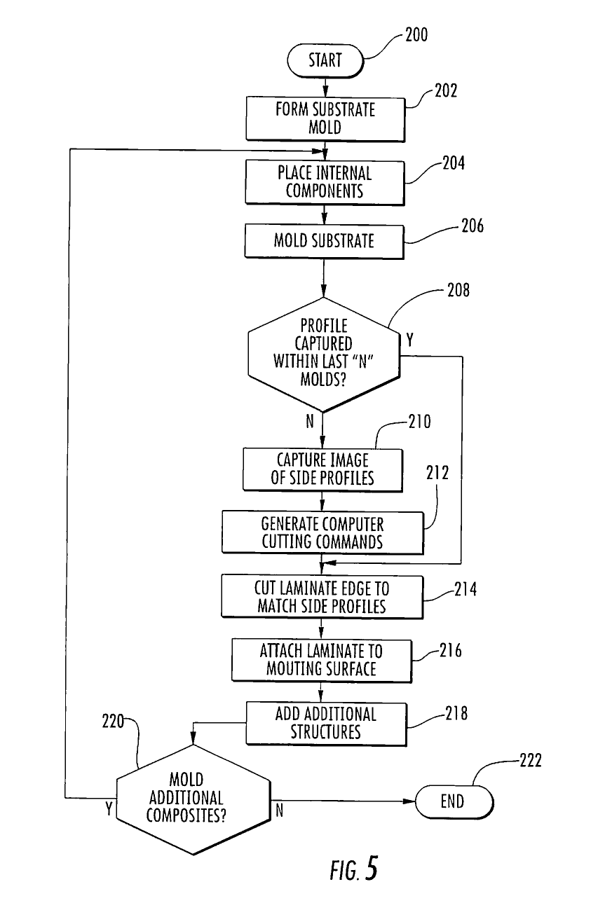

Referring to FIG. 5, a method of making a composite will be explained, according to a further aspect of the present invention. The method begins at block 200. At block 202, a substrate mold is formed. For replicating the appearance of stone, such as slate, a stone slab can be used to form the mold. Various methods of forming molds are known to those skilled the art, and the present invention is not necessarily limited to a particular method.

At block 204, internal components are placed in the mold. For example, components such as a fluid conduit or reinforcement strips could be placed in the mold prior to molding. At block 206, a substrate is molded. Any components placed in the mold are thereby molded in place.

At block 208, it is determined whether substrate side profiles were captured within a predetermined number (N) of substrate moldings, for instance, within the last fifty moldings. If the profiles were not captured within the predetermined number of moldings, then an image is captured, for example a digital picture, of the substrate side profiles at block 210.

At block 212, computer cutting commands are generated. For instance, a plurality of points could be manually or automatically plotted along the image of the side profiles and used to generate computer numerical control (CNC) commands. At block 214, the edges of a laminate are cut to match the side profiles using the computer cutting commands.

Referring again to block 208, if the substrate side profiles were captured within the predetermined number of molds, then blocks 210 and 212 are omitted and the laminate is cut based on the existing set of computer cutting commands. Under some circumstances, the side profiles of a later-molded substrate may not closely match the side profiles of an earlier-molded substrate used to generate an earlier set of computer cutting commands; for example, due to degradation or deformation of the mold over time. The determination of block 208 can advantageously compensate for this effect.

At block 216, the laminate is attached to a mounting surface of the substrate, for example, using an adhesive. At block 218, additional structures are added. For instance, for the composite 110 used in the fountain assembly 100, the additional structures could include other components of the fountain assembly 100. Additional composites are formed by repeating blocks 204-218, if desired (see block 220). Otherwise, the method ends at block 222.

The above embodiments are described for exemplary and illustrative purposes; the present invention is not necessarily limited to such embodiments. Instead, those skilled in the art will appreciate that numerous modifications, as well as adaptations for particular circumstances, are possible within the scope of the present invention.

Although particularly advantageous to replicate the appearance of stone, and most particularly, slate, the present invention is not necessarily limited to such composites.

Also, the present invention is not necessarily limited to particular dimensions or designs. The contact area of the mounting surface need not necessarily be coextensive with the laminate. For instance, the mounting surface and laminate could contact only along respective edges thereof.

Additionally, although the present invention is particularly advantageous for use in connection with fountain applications, the present invention is not necessarily limited to such applications.

The term “crenellated” as used herein generally refers to a plurality of notches formed along an edge, and does not necessarily require a particular geometry, regular interval or periodicity for the notches.

The term “cutting” as used herein refers generically to altering the laminate edge profiles, and is not necessarily limited to a particular process. For example, cutting could also include boring, milling and water and laser cutting operations.

The present invention does not necessarily include a determination like that of block 208. For example, the determination could be omitted or another determination could be used to compensate for any mold degradation or deformation. For instance, an image could be captured of each molded substrate and compared to the image used to generate the computer cutting commands. If the image of a given substrate differs from the image used to generate the computer cutting commands outside of a given tolerance, computer cutting commands could be regenerated at that time.

The foregoing is not an exhaustive list of possible modifications and adaptations. Rather, those skilled in the art will appreciate that these modifications and adaptations fall within the scope of the invention as herein shown and described.

What is claimed is:

1. A fountain assembly comprising:
a substrate having a mounting surface and a substrate side, the substrate side having an irregular profile;
a stone laminate attached to the mounting surface, a laminate edge being substantially aligned with the substrate side and substantially matching the profile thereof;
a fluid reservoir arranged to collect fluid passing over the stone laminate;
a pump for pumping fluid from the reservoir to a position from which the fluid can pass over the stone laminate; and
a fluid conduit for carrying the fluid, the fluid conduit extending at least partially between the fluid reservoir and the position.

2. The assembly of claim 1, wherein the fluid conduit is arranged within the substrate.

3. The assembly of claim 1, wherein a collection volume is defined between corresponding portions of the stone laminate and the substrate for collecting fluid immediately prior to passing over the stone laminate.

4. The assembly of claim 3, wherein another laminate edge is crenellated in the area of the collection volume.

5. The assembly of claim 1, wherein the substrate includes reinforcement members molded therein.

6. The assembly of claim 1, wherein the substrate side profile substantially replicates a side of a rough-hewn slate slab.

7. A composite comprising:
a substrate having a mounting surface and a first substrate side having an irregular profile; and
a laminate attached to the mounting surface, a first laminate edge being substantially aligned with the first substrate side and substantially matching the profile thereof.

8. The assembly of claim 7, wherein a second substrate side has an irregular profile and a second laminate edge is substantially aligned with the second substrate side and substantially matches the profile thereof.

9. The assembly of claim 7, wherein the first substrate side includes a plurality of layers and the first laminate edge matches the profile of the layer most proximate to the mounting surface.

10. The assembly of claim 7, further comprising a fluid conduit associated with the substrate.

11. The assembly of claim 10, wherein the fluid conduit is arranged within the substrate.

12. The assembly of claim 7, wherein the first substrate side replicates a rough-hewn slate side.

13. The assembly of claim 7, wherein the laminate is stone.

14. The assembly of claim 7, wherein the substrate is a molded synthetic material.

15. A method of making a composite comprising:
substantially aligning an edge of a stone laminate with a side of substrate; and
attaching the stone laminate to a mounting surface of the substrate;
wherein the edge of the stone laminate substantially matches an irregular profile of the side of the substrate.

16. The method of claim 15, further comprising cutting the edge of the stone laminate to substantially match the irregular profile of the side of the substrate.

17. The method of claim 16, wherein cutting the edge of the stone laminate to substantially match the irregular profile of the side of the substrate includes:
capturing an electronic image of the irregular profile of the side of the substrate;
generating computer commands for a computer-controlled cutting machine based on the captured image; and
cutting the edge of the stone laminate using the computer-controlled cutting machine.

18. The method of claim 15, further comprising molding the substrate.

19. The method of claim 18, further comprising forming a plurality of composites by repetition of the molding, aligning and attaching steps.

20. The method of claim 19, further comprising:
capturing an electronic image of the irregular profile of the side of a molded substrate;
generating computer commands for a computer-controlled cutting machine based on the captured image; and
cutting the edge of the stone laminate using the computer-controlled cutting machine;
wherein, after a predetermined number of mold uses, an electronic image of an irregular profile of a more recently molded substrate is captured and used to regenerate computer commands for the computer-controlled cutting machine.
